(19) United States
(12) Patent Application Publication
(10) Pub. No.: US 2012/0303830 A1
(43) Pub. Date: Nov. 29, 2012

(54) DATA PROCESSING DEVICE AND DATA PROCESSING METHOD

(75) Inventor: Tatsuya Tobioka, Tokyo (JP)

(73) Assignee: THE BANK OF TOKYO - MITSUBISHI UFJ, LTD., Tokyo (JP)

(21) Appl. No.: 13/237,601

(22) Filed: Sep. 20, 2011

(30) Foreign Application Priority Data
May 27, 2011 (JP) 2011-119124

(51) Int. Cl. G06F 15/16

(52) U.S. Cl. 709/229

(57) ABSTRACT

The data processing device includes a registration data receptor which receives first registration data sent from a client, a URL generator which generates a URL which includes the first registration data, a URL notification unit which notifies the client of the URL, a login URL processor which receives the URL from the client, and extracts the URL from the first registration data while displaying to the client a login screen corresponding to the URL, an authentication request receptor which receives an authentication request which includes second registration data sent from the client, and an authentication enforcement unit which judges whether to authenticate the client according to whether the first registration data and the second registration data match.

### CROSS REFERENCE TO RELATED APPLICATION

This application is based upon and claims the benefit of priority from the prior Japanese Patent Application No. 2011-119124, filed on May 27, 2011; the entire contents of which are incorporated herein by reference.

### BACKGROUND OF THE INVENTION

### Field of the Invention

The present invention is related to a device and method for performing authentication. In particular, the present invention is related to a device and method for performing authentication of a client in system with increased security.

Conventionally, in a system arranged with a server and a client authentication of a user who uses the client is performed by storing authentication data such as a combination of a user ID and password in advance, and comparing the authentication data sent from the client with authentication data stored in the server (For example, see Japan Laid Open Patent 2007-310630).

However, when the number of users increases the amount of authentication data stored in the server also increases. As a result, there is a danger that authentication data stored in the server may be leaked resulting in unauthorized access to the accounts of many users.

Thus, it is an aim of the present invention to provide a data processing device and data processing method for performing authentication without increasing the burden on users and without storing authentication data of a registered user in the server.

### BRIEF SUMMARY OF THE INVENTION

The data processing device related to one embodiment of the present invention may include a registration data receptor which receives first registration data sent from a client, a URL generator which generates a URL which includes the first registration data, a URL notification unit which notifies the client of the URL, a login URL processor which receives the URL from the client, and extracts the URL from the first registration data while displaying to the client a login screen corresponding to the URL, an authentication request receptor which receives an authentication request which includes second registration data sent from the client, and an authentication enforcement unit which judges whether to authenticate the client according to whether the first registration data and the second registration data match.

The data processing device relating to another embodiment of the present invention may include a registration data receptor which receives first registration data sent from a client, a calculator which calculates a first hash value with the first registration data as a key, a URL generator which generates a URL which includes the first hash value, a URL notification unit which notifies the client of the URL, a login URL processor which receives the URL from the client, and extracts the first hash value from the URL while displaying to the client a login screen corresponding to the URL, an authentication request receptor which receives an authentication request sent from the client, and an authentication enforcement unit which calculates a second hash value with the authentication request as a key, and judges whether to authenticate the client according to whether the first hash value and the second hash value match.

The data processing device related to another embodiment of the present, invention may include a registration data receptor which receives first registration data sent from a client, a calculator which calculates a first hash value with the first registration data as a key, an encryption unit which encrypts the first registration data and generates encrypted registration data a URL generator which generates a URL which includes the first hash value and the encrypted registration data, a URL notification unit which notifies the client of the URL, a login URL processor which receives the URL from the client, and extracts the first hash value from the URL and extracts the encrypted registration data from the URL, and an authentication enforcement unit which decrypts the encrypted registration data to the first registration data, calculates a second hash value with the decrypted first registration data as a key, and judges whether to authenticate the client according to whether the first hash value and the second hash value match.

in addition, a data processing method related to an embodiment of the present invention may include receiving first registration data sent from a client, calculating a first hash value using the first registration data as a key, generating a URL which includes the first hash value, notifying the client of the URL which is generated, receiving the URL from the client, displaying a login screen to the client, extracting the first hash value from the URL, receiving an authentication request from the client, calculating a second hash value using the authentication request as a key, and judging whether to authenticate the client according to whether the first hash value and the second has value match.

According to the present invention, a data processing device is provided with can perform authentication without introducing any particular program in a client side and without storing authentication data in the data processing device, that is, server side.

### BRIEF DESCRIPTION OF THE DRAWINGS

FIG. 1 is a functional block diagram which shows a structure of a data processing system which includes a data processing device related to one embodiment of the present invention, FIG. 2 is a sequence diagram for explaining the flow of data in the data processing system related to one embodiment of the present invention, FIG. 3 is a sequence diagram for explaining in detail the flow of data in a registration unit 110, FIG. 4 is a flowchart for explaining the process of user registration for using a server via a client in the data processing device related to one embodiment of the present invention, FIG. 5A is a sequence diagram for explaining in detail the flow of data in an authentication unit 120, FIG. 5B is a sequence diagram for explaining in detail the flow of data in an authentication unit 120, FIG. 6A is a flowchart for explaining the process of logging in to a data processing device for using a service via a client in the data processing device related to one embodiment of the present invention, FIG. 6B is a flowchart for explaining the process of logging in to a data processing device for using a service via a client in the data processing device related to one embodiment of the present invention, FIG. 7 is a functional block diagram which shows the structure of a data processing system which includes a data processing device related to another embodiment of the present invention, FIG. 8 is a sequence diagram which shows the flow of data in a data processing system related to another embodiment of the present invention, FIG. 9 is flowchart for explaining the process of user registration for using a service via a client in a data processing device related to another embodiment of the present invention, and FIG. 10 is a flowchart for explaining the process of logging in to a data processing device for using a service via a client in a data processing device related to another embodiment of the present invention.

### DETAILED DESCRIPTION OF THE INVENTION

Examples for performing the present invention are explained as a number of embodiments below. Furthermore, the present invention is not limited to these embodiments and various alternative embodiments are possible.

### First Embodiment

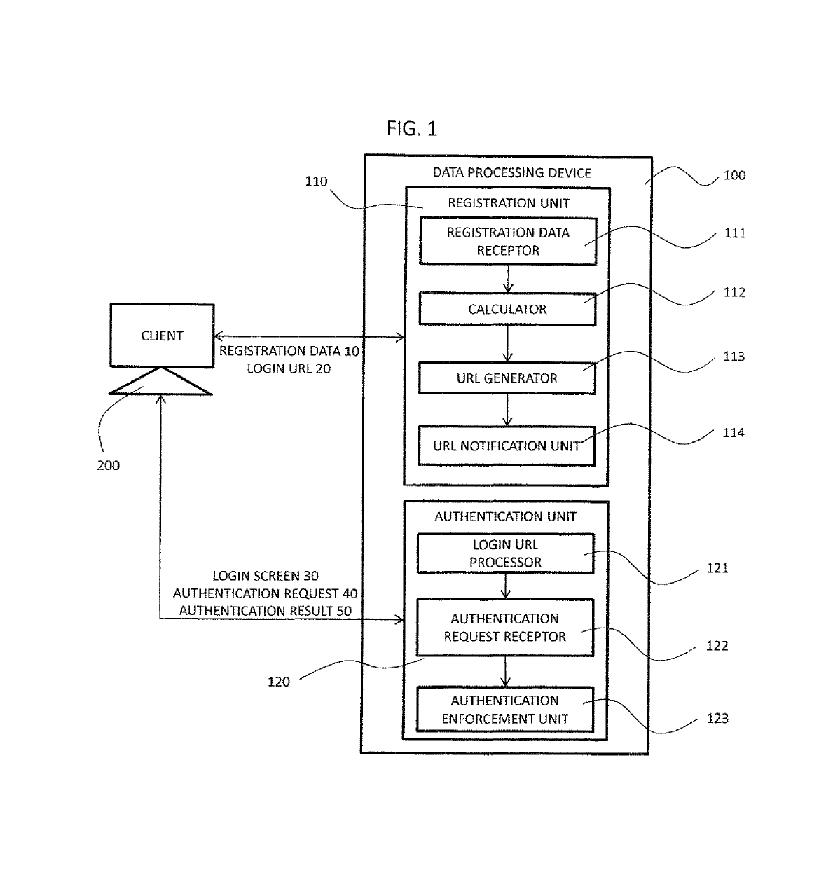

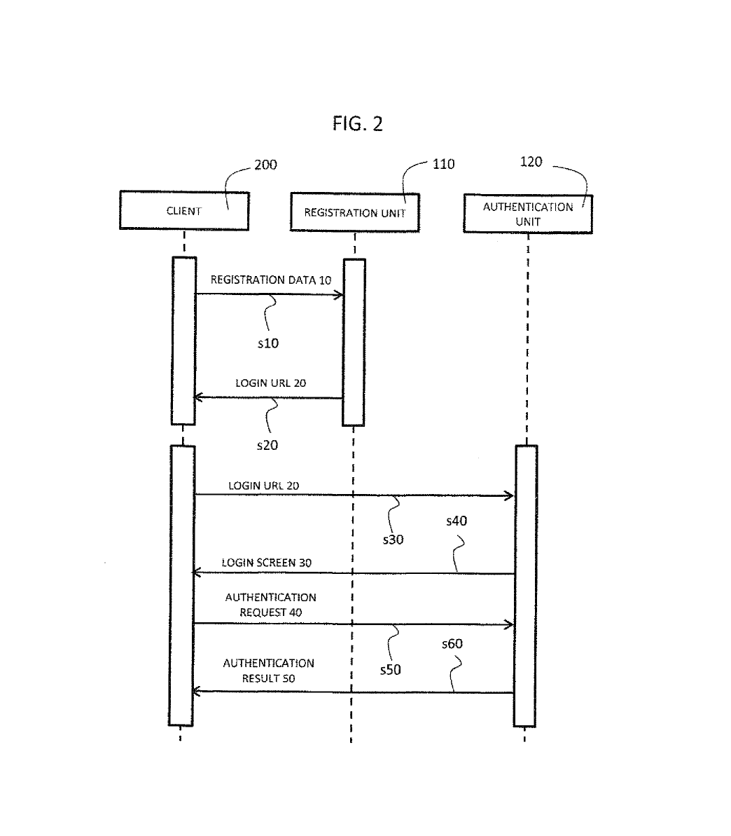

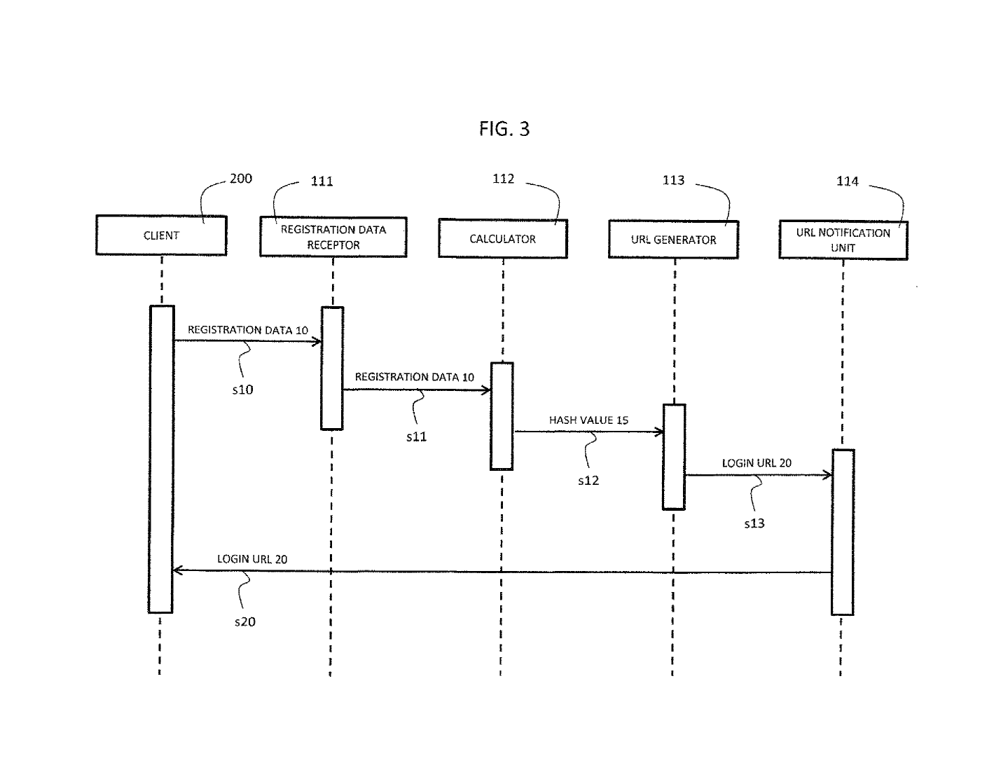

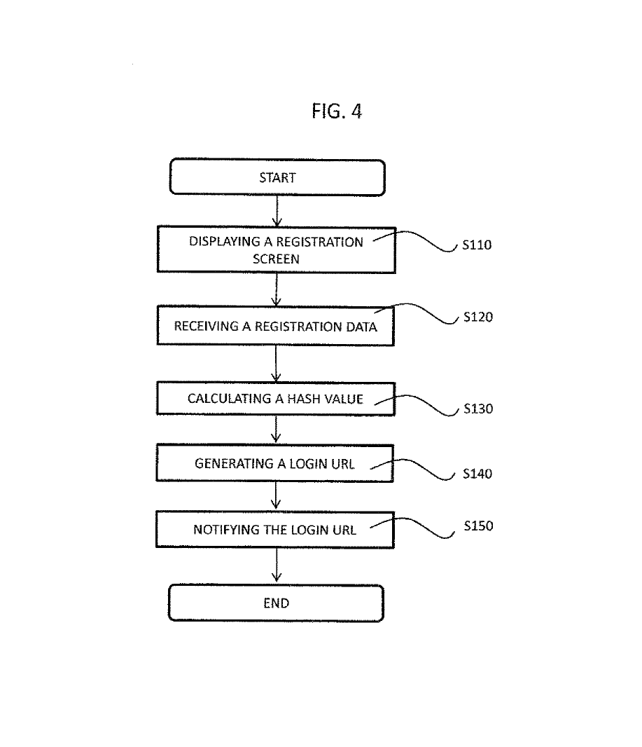

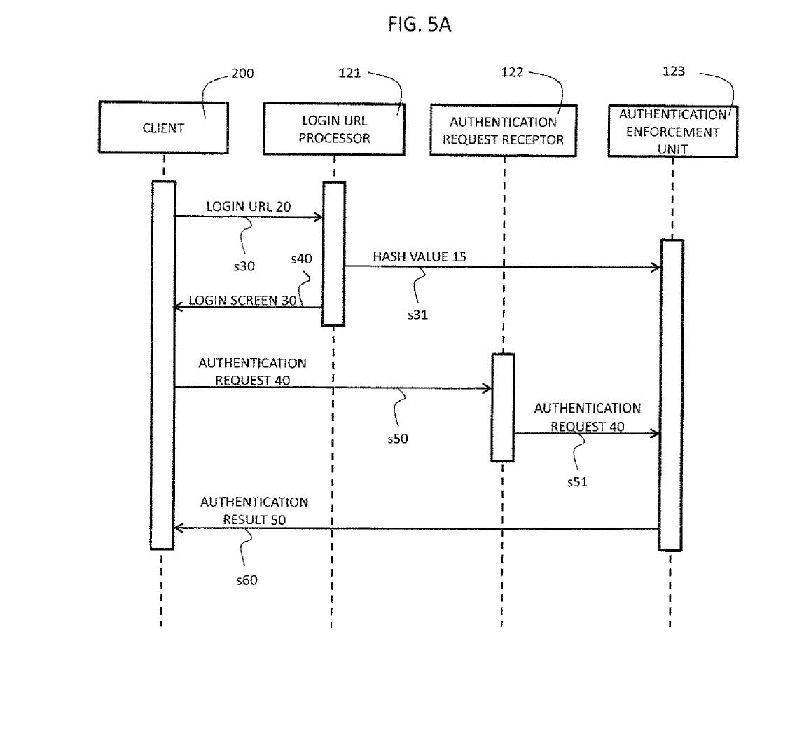

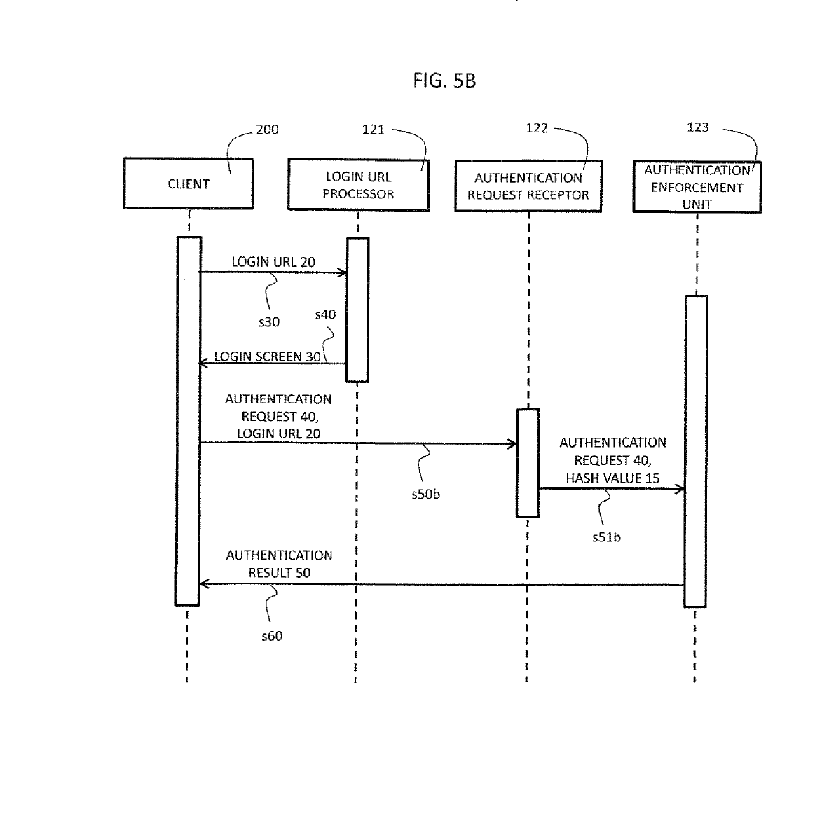

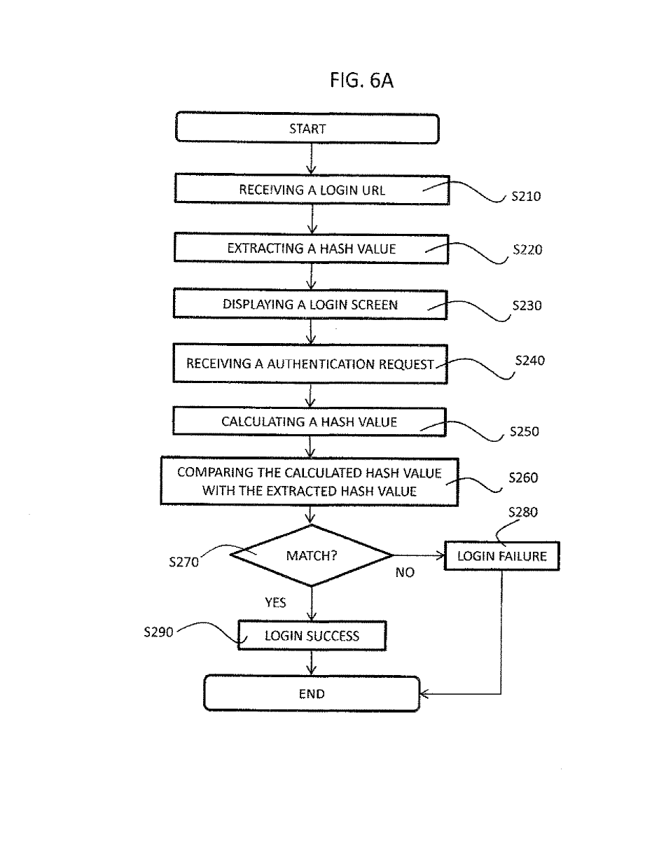

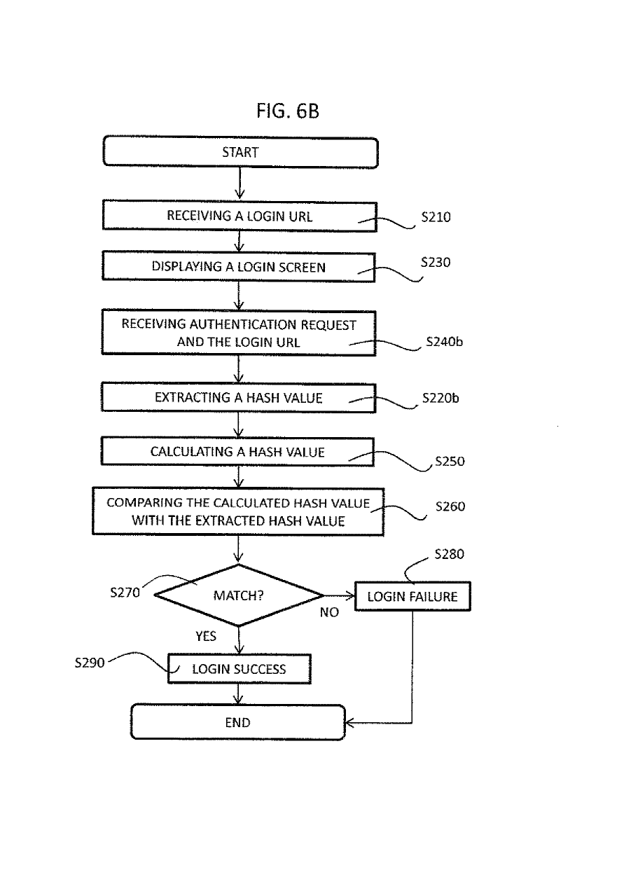

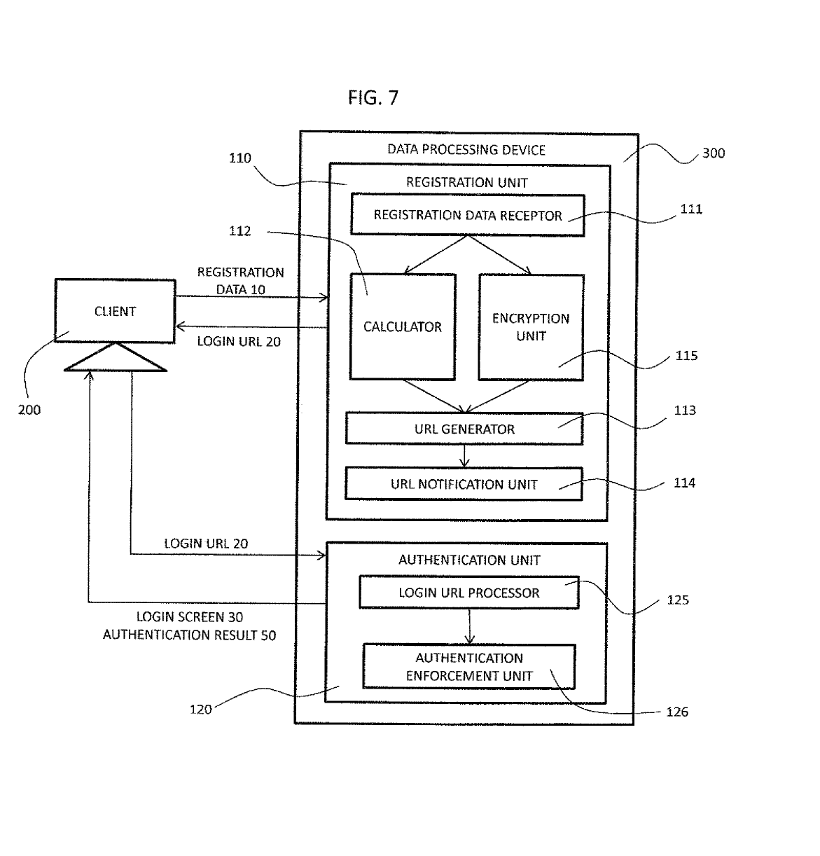

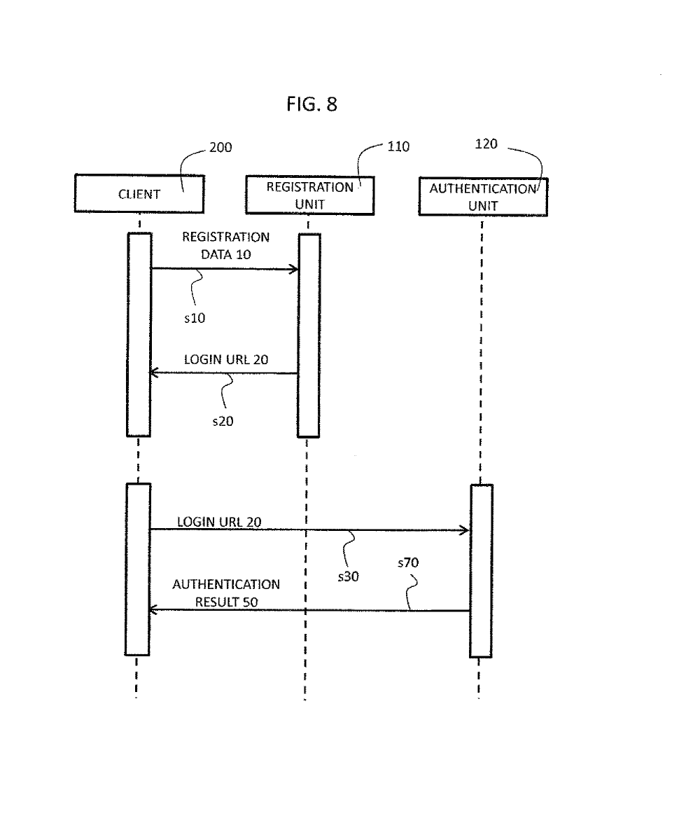

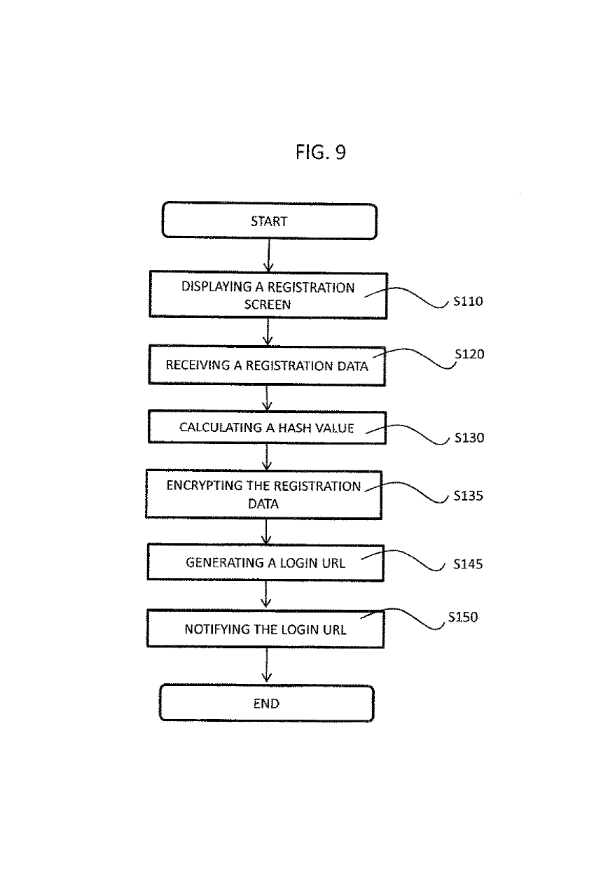

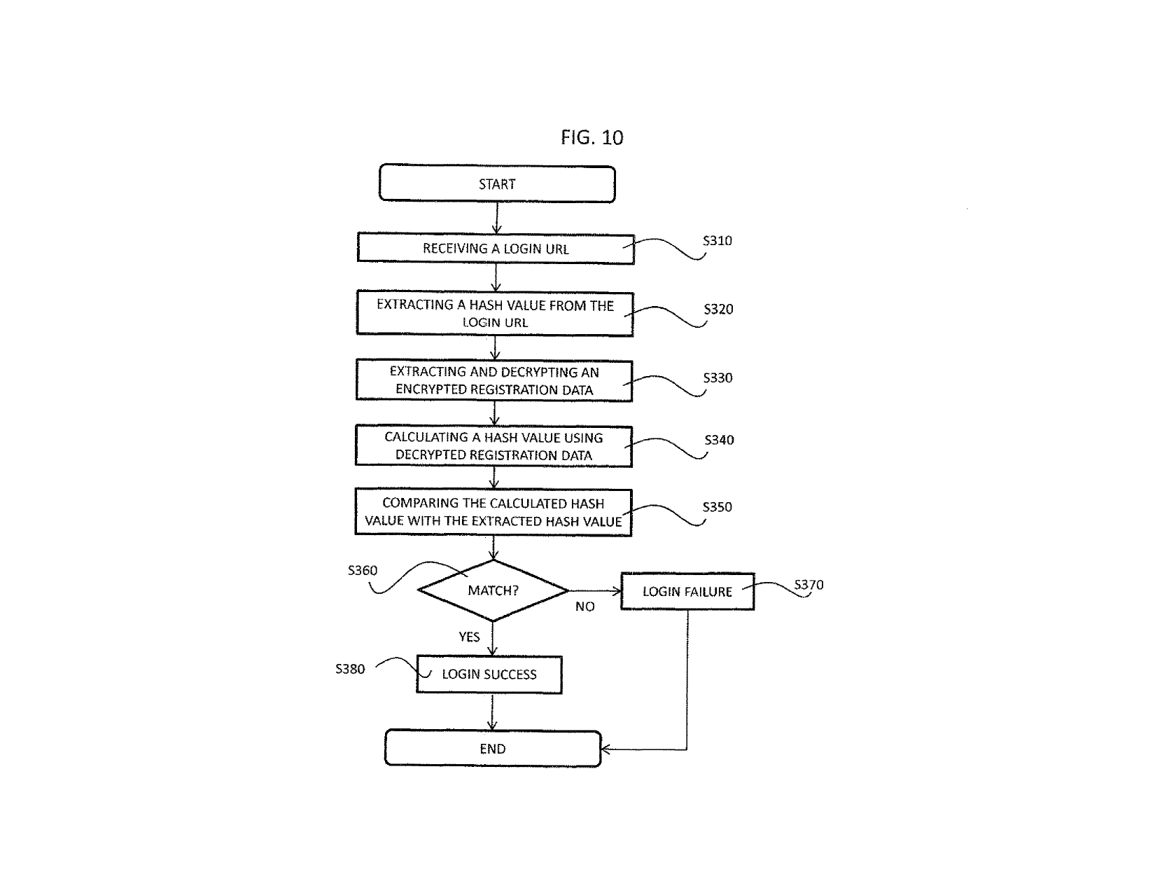

FIG. 1 is a functional block diagram of a data processing system related to the first embodiment of the present invention.

Referring to FIG. 1, the data processing system related to the first embodiment is arranged with a data processing device 100 and a client 200. The data processing device 100 includes a registration unit 110 and an authentication unit 120. The data processing device 100 is, for example, one or more servers which can be connected to one or more networks and is network connected with a client 200. The client 200 is a terminal device which is operated by a user. The client 200 installs programs to devices which include CPU's (central processing unit) such as personal computers, PDA's, mobile phones, smartphones etc.

The registration unit 110 is a component which is used in the registration for using a service provided by the data processing device 100 in the client 200, and includes a registration data receptor 111, a calculator 112, a URL generator 113 and a URL notification unit 114. In addition, after user registration the authentication unit 120 authenticates when the client 200 logs in for using a service. The authentication unit 120 includes a login URL processor 121, an authentication request receptor 122 and an authentication enforcement unit 123.

The registration data receptor 111 receives registration data 10 sent from the client 200. The registration data 10 is, for example, a user ID and password used when using a service. In addition, just the user ID can be input in the client and a password corresponding to the user ID can be generated in the data registration processing device 100. In addition, data which specifies a user such as a user name, address etc can be input as registration data in the client 200 and user ID and password corresponding to data input to the client 200 can be generated in the data processing device 100. The user ID and/or password generated may be written on a web page as a reply to the registration data 10, or may be returned to an email address included in the registration data 10 or a postal address.

The calculator 112 calculates a hash value 15 of the registration data 10 using a hash function. The function used for the calculation is, for example, MD5 or SHA-1, SHA-256 and other has functions may also be used. In addition, a hash value 15 in which a salt value is added to the registration data 10 may be calculated so that a reverse calculation of the hash value 15 is more difficult than when a salt value is not used and it is more difficult for a third party to reverse calculate the registration data 10 from the hash value 15 which can prevent leaks.

The URL generator 113 generates a login URL which includes the hash value 15 calculated in the calculator 112. Specifically, a hash value 15 is added to a URL such as [http://www.example.co.jp/login.html] and a login URL 20 [http://www.example.co.jp/login.html?q=hash value 15] is generated. The hash value may be added as a query part in the URL shows in this example. In this way, it is sufficient to prepare 1 URL which specifies the position of a login screen for actual access regardless of the number of users. In the case of this example, a URL which specifies the position of the login screen becomes [http://www.example.co.jp/login.html] and the query part [?q=hash value 15] is attached to the URL.

Furthermore, the hash value 15 may be encrypted using a means for encrypting a hash value and included in the login URL 20.

A specific example is shown of generating a login URL 20 from the registration data 10. The contents of the registration data 10 are a user ID and password. In the case where the user ID is [user1], the password is [password1] and the salt value is [ty], these are combined to produce a key [user1password1ty], and when a hash value is calculated using MD5 as the hash function, the hash value 15 becomes [6f2ca242c40b3589b0fdf03f04da719a]. When the URL to display the login screen is [http://www.example.co.jp/login.html], the login URL 20 which is created using the hash value 15 becomes [http://www.example.co.jp/login.html?q=6f2ca242c40b3589b0fdf03f04da719a].

The URL notification unit 114 notifies the client 200 of the login URL 20 generated by the URL generator 113. The URL notification unit 114 may send notification via electronic mall, display the notification on the Web browser of the client 200 or an alternative means may be employed as the method of notifying the client 200. As an example, a method can be used which sends an electronic mail including the generated login URL 20 together with the registration contents to an electronic mail address specified by a user in the client 200 as notification of completion of registration. In addition, in the case where the user ID and/or password is generated in the data processing device 100, the user is notified of the user ID and/or password generated by the same or different route as notification of the generated URL. For example, the user ID and password are notified to the user via post or fax etc and the generated URL is notified to the user by electronic mail.

Next, the operation of the authentication unit 120 is explained when the client 200 logs in to use a service in the data processing device 100 using the login URL notified to the client 200 by the URL notification unit 114.

In order to request authentication, for example, the login URL 20 notified when registering is input in the web browser of the client 200 and sent to the data processing device 100. For example, the notified URL is stored in advance in the bookmarks of the web browser, the bookmarks are read and the notified URL is accessed. Alternatively, in the case where the URL is notified via electronic mail, the mail which performs the notification is displayed on the mailers display screen and the notified URL is clicked etc.

When the login URL 20 is received the login URL processor 121 of the authentication unit 120 displays the web page used as the login display 30 to the client 200. The user of the client 200 inputs authentication data in the login screen 30, a request for authentication is sent to the data processing device 100 and the authentication unit 120 extracts a hash value 15 included in the login URL 20.

A method of extracting the hash value 15 from the received login URL 20 in the login URL processor 121 with the authentication unit 120 is one example of a method of extracting the hash value 15. However, there are other methods such as recognition of the login URL 20 by the authentication unit 120 as a referrer (HTTP referrer). That is, the data processing device 100 displays a is web page used as the login screen 30 corresponding to the login URL 20 in the client 200. For example, authentication data, such as a user ID and a password, are input into the login screen 30 by a user on the client 200 and an authentication request 40 is sent to the data processing device 100. At this time, the authentication request 40 is sent to the data processing device 100 together with the login URL 20 as the referrer, which is the URL of a web page for the login screen 30. Even in the case where the login URL 20 is recognized as the referrer, because a user not only inputs the login URL 20 in the web browser of the client 200, and sends it to the data processing device 100 but referring during processing of a page after transition of the input and sent URL as a referrer, is also possible using a Web technology standard protocol, it is no longer necessary to introduce a particular program to the client 200. For example, a value of the referrer can be, referred via an environment variable HTTP_REFERER in the CGI (Common Gateway Interface).

The authentication request 40 input by a user in the login screen 30 and sent from the client 200 is received by the authentication request receptor 122. The authentication request receptor 122 outputs the received authentication request 40 to the authentication enforcement unit 123. The same contents as the registration data 10 registered by a user in the registration unit 110, for example, user ID and password, are included in the authentication request 40. However, the authentication request receptor 122 may extract only the data used in authentication in the authentication enforcement unit 123 from the authentication request 40 and output the data to the authentication enforcement unit 123. In the case where the login URL 20 is sent together with the authentication request 40 as the referrer, the authentication request receptor 122 may also send the login URL 20.

Login authentication of the client 200 is performed in the authentication enforcement unit 123 based on the received authentication request 40 and a judgment is made whether to permit authentication or not.

A judgment to permit authentication in the authentication enforcement unit 123 is performed as follows. First; in the authentication requests 40, a hash value is calculated using data, typically a user ID and password, corresponding to registration data 10 used in the calculation of the hash value 15. This hash value is called a second hash value. Then, the second hash value which is calculated is compared with the hash value 15 included within the login URL 20. As a result of the comparison, if the hash values match then login is successful and services offered to the client 200 are begun. On the other hand, if the hash values do not match, login fails and a login failure is notified to the client 200. In the case of a login failure, input of the user ID and password may be requested again or a different authentication method may be used.

Using the data processing device related to the first embodiment of the present invention explained above, it is possible to perform user authentication without storing data necessary for authentication of a user in the data processing device. In addition, authentication is performed while a cumbersome process such as introducing special programs or electronic certificates is not required.

Furthermore, in a more simplified data processing device, the calculator 112 is not included, a login URL 20 which includes registration data 10 as plain text is generated in the login URL generator 113, and this login URL 20 may be used in later processing. In this case, it is possible to easily see the registration data 10 from the login URL 20 which is more inferior from the viewpoint of security than the case where a hash value 15 is used. However, the calculator 112 is no longer necessary and a data processing device which can perform easier authentication at no cost is provided. In addition, high speed authentication is possible since calculation of the hash value 15 is not performed.

Next, the flow of the processes and the flow of data in the registration unit 110 of the data processing device related to first embodiment of the present invention are explained while referring to FIG. 2 to FIG. 4.

FIG. 2 is a sequence diagram for explaining the flow of data in the data processing device related to the first embodiment of the present invention. In in addition, FIG. 3 is a sequence diagram for explaining the flow of data in the registration unit 110. In addition, FIG. 4 is a flowchart for explaining the flow of user registration for using a service in the client 200 in the data processing device related to the first embodiment of the present invention.

Referring to FIG. 2 to FIG. 4, first, a registration screen for inputting registration data is displayed in the client 200 (step S110).

In the registration screen displayed in the client 200, the input registration data 10 is sent to the registration unit 110 and this registration data 10 is received by the registration data reception part 111 in the registration unit 110 (S10, step S120). The registration data reception part 111 outputs the registration data 10 to the calculator 112 from the received registration data 10 (S11).

A hash value 15 is calculated in the calculator 112 using a hash function with a key which includes the registration data 10 (step S130). The calculated hash value 15 is output to the URL generator 13 (S12).

A login. URL 20 is generated in the URL generator 113 using the hash value 15 (step S140), and the generated login URL 20 is output to the URL notification unit 114 (S13). However, as stated above, it is not essential to calculate and output the hash value 15. A login URL including registration data as plain text may be generated and output.

The URL notification unit 114 notifies the client of the login URL 20 via a predetermined format (S20, step S160).

Next, the flow of processes and the flow of data in the authentication unit 120 of the data processing device related to the first embodiment of the present invention is explained while referring to FIG. 5A and FIG. 6A.

Furthermore, input of the registration data does not have to be performed by a user using the client 200. For example, in the case of an application for a bank account or stock trading account, the bank or the stock trading company acts as an intermediary and may notify the user of the generated login URL 20 using post or electronic mail.

FIG. 5A is a sequence diagram for explaining in detail the flow of data in the authentication unit 120 in FIG. 2. FIG. 6A is a flowchart for explaining the process of logging in to a data processing device for using a service via a client in the data processing device related to the first embodiment of the present invention.

Referring to FIG. 2, FIG. 5A and FIG. 6A, the client 200 accesses the login URL 20 notified by the URL notification unit 114 (S30). The login URL 20 is received by the login URL processor 121 (step S210).

The login URL processor 121 extracts a hash value 15 from the login URL 20 (step S220), and outputs the hash value 15 to the authentication enforcement unit (S31).

In addition, the login URL processor 121 sends the login screen 30 to the client 200 (S40), and the login screen 30 is displayed in the client 200 (step S230).

Alternatively, in the case where the login URL 20 is recognized in the recognition part 120 as the referrer, as shown in FIG. 5B and FIG. 6B, the login URL processor 121 does not perform the process in step S220 in which the hash value 15 is extracted from the login URL 20 and the hash value is not output to the authentication enforcement unit (S31). The login URL processor 121 receives the login URL (step S210), sends the login screen 30 to the client 200 (S40) and displays the login screen (step. S230).

The client 200 inputs the registration data 10, for example, user ED and password, into the displayed login screen 30 and sends an authentication request 40 to the authentication request receptor 122 (S50). The authentication request receptor 122 receives the authentication request 40 (step S240). The authentication request receptor 122 outputs the received authentication request 40 to the authentication enforcement unit 123 (S51).

Alternatively, in the case where the login URL 20 is recognized in the recognition part 120 as a referrer, the client 200 inputs the registration data 10 in the displayed login screen 30 and sends the authentication request 40 together with the referrer to the authentication request receptor 122 (S50b). At this time, the referrer is the login URL 20. The authentication request receptor 122 receives authentication request 40 and the login URL 20 which is the referrer (step S240b). The authentication request receptor 122 extracts the hash value 15 from the login URL 20 received as the referrer (step S220b), and outputs the hash value 15 together with the received authentication request 40 to the authentication enforcement unit 123 (S51b).

In the authentication enforcement unit 123 a hash value is calculated from the registration data 10 included in the authentication request 40 (step S250), this calculated hash value is compared with the hash value 15 (step S260) and a judgment is made to allow authentication or not depending on whether they match (step S270). A login failure judgment is given (step S280) in the case where the calculated hash value and the hash value 15 do not match and a login success judgment (step S290) in the case where they match. A subsequent process such as retry may be performed in the case of login failure. The authentication enforcement unit 123 outputs the authentication judgment as an authentication result 50 to the client 200 (S60). In addition, a service is started in the case of a login success.

As stated above, according to the data processing device 100 related to the first embodiment of the present invention, an authentication method is provided whereby it is possible to authenticate a client without storing authentication data on a server, and it is not necessary to install a particular program in the client.

### Second Embodiment

Next, a data processing device 300 related to another embodiment of the present invention is explained while referring to FIG. 7. FIG. 7 is a functional block diagram which shows the structure of a data processing system which includes a data processing device related to the second embodiment of the present invention.

Referring to FIG. 7, the basic structure of the data processing device 300 includes a registration unit 110 and an authentication unit 120 the same as the data processing device 100 explained above referring to FIG. 1. However, the registration unit 110 includes an encryption unit 115 which encrypts registration data 10, and the login URL processor 124 and the authentication enforcement unit 126, both included in the authentication unit 120, perform slightly different processes to the login URL processor 121 and authentication enforcement unit 123, and the authentication request receptor 122 does not have to be arranged in the data processing device 300.

The encryption unit 115 encrypts the registration data 10. Encryption may be performed using a format which can decrypt following the processes performed by the authentication unit 120, and a general encryption method such as a common key encryption method or public key encryption method can be used.

The URL generator 113 adds the registration data 10 encrypted in the encryption unit 115 to the URL as well as the hash value 15 and generates a login URL 20.

The login URL processor 125 receives the login URL 20 from the client 200 the same as the login URL processor 121, extracts the hash value 15, and outputs the hash value 15 to the authentication enforcement unit 126. Furthermore, the login URL processor 125 extracts the encrypted registration data 10 from the login URL 20 and outputs the data to the authentication enforcement unit 126.

The registration data 10 is decrypted by the authentication enforcement unit 126 from the encrypted registration 10. A second hash value is calculated using the decrypted registration data 10 as a key. The same salt value is used in the case where a salt value is used in the calculation of the hash value 15 with respect to the key. The calculated second hash value is compared with the hash value 15 and as a result of the comparison, if the hash values match login is successful and services are offered to the client 200. However; if the hash values do not match, the login fails and the client is notified of the login failure. Re-input of a user ID and password may be requested or a different authentication method may be used in the case of a login failure.

With the data processing device 300 related to the second embodiment of the present invention explained above it is possible to authenticate a user without storing data required for authenticating the user in the data processing device 300. In addition, a simple login authentication is performed because cumbersome processes such as installing a particular program are not required. Furthermore, login authentication of a user can be performed in the data processing device 300 just by accesses the URL which is notified which does not require considerable operation on the part of the user.

The authentication unit in the data processing device related to the second embodiment of the present invention is useful as a simple authentication unit even in the case where it is used alone. However, it is also possible to easily combine the part with another authentication unit which can further improve security. Even when used in combination with another authentication unit, because it is possible to realize an authentication unit in the present embodiment just by a user accessing the login URL 20 in the client when logging in, no further input from a user is required.

Next, the flow of processes and the flow of data in the data processing device related to the second embodiment of the present invention is explained.

FIG. 8 is a sequence diagram which shows the flow of data in the data processing system 300. In addition, FIG. 9 is flowchart which shows the flow of processes in the registration unit 110 in the data processing device 300 and FIG. 10 is a flowchart which shows the flow of processes in the authentication unit 120 in the data processing device 300.

Referring to FIG. 8 and FIG. 9, in the flow of processes and data between the registration unit 110 and client 200, the data processing device 300 displays a registration screen in the client 200 (step S110), the registration unit 110 receives the registration data 10 sent from the client 200 (step S120, S10), a hash value 15 is calculated based on the received registration data 10 (step S130), and the client 200 is notified of the login URL 20 (step S150, S20). These steps are the same as the flow of processes in the registration unit 110 of the data processing device 100 explained using FIG. 2 to FIG. 4. The data processing device 300 is different to the data processing device 100 in that the registration unit 110 encrypts the registration data 10 (step S135), adds the encrypted registration data 10 to the URL together with the hash value 15 and generates a login URL 20 (step S145).

Next, the flow of processes and the flow of data in the authentication unit 120 are explained. Referring to FIG. 8 and FIG. 10, the login URL 20 is received and a hash value 15 is extracted from the login URL 20 (S30, step S310, step S320). These steps are the same as described above for the data processing device 100. However, in the data processing device 300, the encrypted registration data is extracted from the login URL 20, the registration data 10 is decrypted (step S330) and a hash value is calculated, using the decrypted registration data 10 as a key (step S340), the calculated hash value and the hash value 15 are compared (step S350) and the steps after step S360 which determines whether the hash values match are the same as the steps S270 step S290. Authentication by an alternative login method can also be used in the case of a login failure.

As described above, according to the data processing device 300 related to the second embodiment of the present invention it is possible to authenticate a client without storing authentication data in a server, and an authentication method is proposed in which it is not necessary to install a particular program in the client and input of a user ID and password when logging in is not required.

What is claimed is:

1. A data processing device comprising:
a registration data receptor which receives first registration data sent from a client;
a URL generator which generates a URL which includes the first registration data;
a URL notification unit which notifies the client of the URL;
a login URL processor which receives the URL from the client, and extracts the URL from the first registration data while displaying to the client a login screen corresponding to the URL;
an authentication request receptor which receives an authentication request which includes second registration data sent from the client; and
an authentication enforcement unit which judges whether to authenticate the client according to whether the first registration data and the second registration data match.

2. The data processing device according to claim 1, wherein the URL generator communalizes parts except for the first registration data, and generates a URL.

3. The data processing device according to claim 2, wherein the URL generated by the URL generator, except for the first registration data, corresponds to the login screen.

4. A data processing device comprising:
a registration data receptor which receives first registration data sent from a client;
a calculator which calculates a first hash value with the first registration data as a key;
a URL generator which generates a URL which includes the first hash value;
a URL notification unit which notifies the client of the URL;
a login URL processor which receives the URL from the client, and extracts the first hash value from the URL while displaying to the client a login screen corresponding to the URL;
an authentication request receptor which receives an authentication request sent by the client; and
an authentication enforcement unit which calculates a second hash value with the authentication request as a key, and performs an authentication of the client according to whether the first hash value and the second hash value match.

5. The data processing device according to claim 1, wherein the URL is received as a referrer by the authentication request receptor.

6. The data processing device according to claim 4, wherein the URL is received as a referrer by the authentication request receptor.

7. The data processing device according to claim 1, wherein the URL generator communalizes parts except for the first hash value, and generates a URL.

8. The data processing device according to claim 7, wherein the URL generated by the URL generator, except for the first hash value, corresponds to the login screen.

9. The data processing device according to claim 4, wherein the URL generator communalizes parts except for the first hash value and generates a URL.

10. The data processing device according to claim 9, wherein the URL generated by the URL generator, except for the first hash value, corresponds to the login screen.

11. A data processing device comprising:
a registration data receptor which receives first registration data sent from a client;
a calculator which calculates a first hash value with the first registration data as a key;
as an encryption unit which encrypts the first registration data and generates encrypted registration data;
a URL generator which generates a URL which includes the first hash value and the encrypted registration data;
a URL notification unit which notifies the client of the URL;
a login URL processor which receives the URL from the client, extracts the first hash value from the URL, and extracts the encrypted registration data from the URL; and
an authentication enforcement unit which decrypts the encrypted registration data to the first registration data, calculates a second hash value with the decrypted registration data as a key, and performs an authentication of the client according to whether the first hash value and the second hash value match.

12. The data processing device according to claim 1, wherein the URL notification unit notifies the client of the URL via electronic mail.

13. A data processing method comprising:
receiving first registration data sent from a client;
calculating a first hash value using the first registration data as a key;
generating a URL which includes the first hash value;
notifying the client of the generated URL;
receiving the URL from the client;
displaying a login screen to the client;
extracting the first hash value from the URL;
receiving an authentication request from the client;
calculating a second hash value using the authentication request as a key; and
performing authentication of the client according to whether the first hash value and the second has value match.
